(19) United States
(12) Patent Application Publication
(10) Pub. No.: US 2026/0012881 A1
(43) Pub. Date: Jan. 8, 2026

(54) Enhanced Reduced Neighbor Report for Improved Access-Point Discovery

(71) Applicant: Apple Inc., Cupertino, CA (US)

(72) Inventors: Neelakantan Nurani Krishnan, San Diego, CA (US); Anuj Batra, Redwood City, CA (US); Jarkko L. Kneckt, Los Gatos, CA (US); Pooya Monajemi, Sunnyvale, CA (US); Yong Ho Seok, Cupertino, CA (US); Yong Liu, Campbell, CA (US)

(21) Appl. No.: 19/261,579

(22) Filed: Jul. 7, 2025

Related U.S. Application Data
(60) Provisional application No. 63/668,725, filed on Jul. 8, 2024.

(51) Int. Cl. H04W 48/16; H04B 17/318; H04W 74/0816; H04W 84/12

(52) U.S. Cl. CPC H04W 48/16; H04B 17/318; H04W 74/0816; H04W 84/12

(57) ABSTRACT

An electronic device is described. This electronic device can include: an antenna node communicatively coupled to an antenna; and an interface circuit, communicatively coupled to the antenna node, that communicates with a second electronic device. During operation, the interface circuit can provide, addressed to at least the second electronic device, a request for an enhanced reduced neighbor report (RNR). The interface circuit can receive the enhanced RNR, where the enhanced RNR includes information specifying a non-collocated neighbor access-point identified by the second electronic device. Note that the enhanced RNR can be compatible with an IEEE 802.11bn standard. Moreover, the second electronic device can include a second access point and the electronic device can include a station or client that is associated with the second access point.

### CROSS-REFERENCE TO RELATED APPLICATION

This application claims the benefit of U.S. Provisional Application No. 63/668,725, entitled “Enhanced Reduced Neighbor Report for Improved Access-Point Discovery,” filed Jul. 8, 2024, the contents of which are hereby incorporated by reference.

### FIELD

The described embodiments relate, generally, to wireless communication among electronic devices, including the use of an enhanced or special reduced neighbor report (RNR) for improved access-point discovery.

### BACKGROUND

Many electronic devices communicate with each other using wireless local area networks (WLANs), such as those based on a communication protocol that is compatible with an Institute of Electrical and Electronics Engineers (IEEE) 802.11 standard (which is sometimes referred to as ‘Wi-Fi’).

In Wi-Fi communication, an RNR is an out-of-band discovery tool used by an access point to communicate information about one or more neighboring access points. An RNR facilitates efficient access-point discovery by non-access-point stations. An RNR can be present in beacon or probe response frames (excluding multi-link-probe-response).

However, in practice, an RNR typically carries information regarding collocated access points affiliated with the same access-point multi-link device (MLD) (e.g., a single physical device that hosts multiple access points).

Moreover, non-access-point stations will usually have to perform in-channel scans to discover non-collocated neighbor access points and/or access-point MLDs. Furthermore, a conventional RNR often contains only minimal information about the reported neighbor access point(s). Consequently, a non-access-point station may have to perform one or more channel scans to obtain relevant information about the one or more access points reported in an RNR. Channel scans are expensive for a non-access-point station to perform, both in terms of time and power consumption.

### SUMMARY

Embodiments of an electronic device are described. This electronic device can include: an antenna node communicatively coupled to an antenna; and an interface circuit, communicatively coupled to the antenna node, that communicates with a second electronic device. During operation, the interface circuit provides, addressed to at least the second electronic device, a request for an enhanced RNR. The interface circuit receives the enhanced RNR, where the enhanced RNR includes information specifying a non-collocated neighbor access-point identified by the second electronic device.

Note that the enhanced RNR can be compatible with an IEEE 802.11bn standard.

Moreover, the second electronic device can include a second access point and the electronic device can include a station or client that is associated with the second access point.

Furthermore, the enhanced RNR can specify a set of access points. The set of access points can include the non-collocated neighbor access point, and the electronic device can measure downlink receive signal strength indications (RSSIs) for one or more of the set of access points. Additionally, the electronic device can select a third access point to associate with based at least in part on the enhanced RNR and the measured downlink RSSI for the third access point. For example, the electronic device can measure: the downlink RSSI during exchange of a request-to-send (RTS) frame and a clear-to-send (CTS) frame with the third access point; the downlink RSSI in less than 0.5 ms; the downlink RSSI using a physical preamble; and/or the downlink RSSI using an L-LTF field.

In some embodiments, the request for the enhanced RNR can be included in a probe request and the enhanced RNR can be included in a probe response. For example, the request for the enhanced RNR can be included in a request element in the probe request and the request element can include ‘201.’ Moreover, the probe request can include an extended capabilities element and the extended capabilities element can include bit 110 equal to ‘1.’

Furthermore, the probe request can include a selective service set (SSID) list or a short SSID list to request information about one or more SSIDs associated with one or more corresponding access points. Note that the probe request can include a time duration of the enhanced RNR.

Additionally, the information can be based at least in part on a type of the non-collocated neighbor access-point. For example, the type can include or can indicate which Institute of Electrical and Electronics Engineers (IEEE) 802.11 standard(s) the non-collocated neighbor access-point is compatible.

In some embodiments, the enhanced RNR can include a target beacon transmission time (TBTT) information field type equal to ‘2.’

Note that the enhanced RNR can include one or more of: neighbor access-point dynamic attributes; multi-link device (MLD) parameters; or multi-link mobility domain (MLMD) parameters.

Moreover, the enhanced RNR can include one or more of: a physical layer version, physical layer capabilities, security support, or basic service set (BSS) load.

Other embodiments describe the second electronic device that performs counterpart operations to at least some of the operations performed by the electronic device. For example, the second electronic device can include: an antenna node communicatively coupled to an antenna; and an interface circuit, communicatively coupled to the antenna node, that communicates with the electronic device. During operation, the interface circuit receives, associated with the electronic device, a request for an enhanced RNR. The interface circuit provides, addressed to the electronic device, the enhanced RNR, where the enhanced RNR includes information specifying a non-collocated neighbor access-point of the second electronic device.

Other embodiments describe integrated circuits (such as the interface circuit) for use with the electronic device or the second electronic device. The integrated circuits can perform at least some of the aforementioned operations.

Other embodiments describe a computer-readable storage medium for use with the electronic device and/or the second electronic device. When program instructions stored in the computer-readable storage medium are executed by the electronic device or the second electronic device, the program instructions can cause the electronic device or the second electronic device to perform at least some of the aforementioned operations of the electronic device or the second electronic device.

Other embodiments describe methods. The methods include at least some of the aforementioned operations performed by the electronic device or the second electronic device.

This Summary is provided for purposes of illustrating some exemplary embodiments, so as to provide a basic understanding of some aspects of the subject matter described herein. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The included drawings are for illustrative purposes and serve only to provide examples of possible structures and arrangements for the disclosed systems and techniques for intelligently and efficiently managing communication between multiple associated user devices. These drawings in no way limit any changes in form and detail that can be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1 is a block diagram illustrating an example of communication between electronic devices.

FIG. 2 is a block diagram illustrating an example of communication between electronic devices.

FIG. 3 is a flow diagram illustrating an example method for requesting an enhanced reduced neighbor report (RNR) using an electronic device of FIG. 1 or 2.

FIG. 4 is a flow diagram illustrating an example method for receiving an enhanced RNR using the electronic device of FIG. 1 or 2.

FIG. 5 is a drawing illustrating an example of communication between the electronic devices of FIG. 1 or 2.

FIG. 6 is a drawing illustrating existing communication between access points.

FIG. 7 is a drawing illustrating existing communication between access points and a non-collocated station.

FIG. 8 is a drawing illustrating an example of communication between access points.

FIG. 9 is a drawing illustrating an example of communication between access points.

FIG. 10 is a drawing illustrating an example of communication between access points.

FIG. 11 is a drawing illustrating an example of a probe-request frame.

FIG. 12-15 are drawings illustrating examples of RNR elements.

FIG. 16 is a drawing illustrating an example of a receive signal strength indications (RSSI) measurement.

FIG. 17 illustrates an example of an electronic device of FIG. 1 according to some embodiments of the disclosure.

Note that like reference numerals refer to corresponding parts throughout the drawings. Moreover, multiple instances of the same part are designated by a common prefix separated from an instance number by a dash.

### DETAILED DESCRIPTION

In a first group of embodiments, an electronic device is described. This electronic device can include: an antenna node communicatively coupled to an antenna; and an interface circuit, communicatively coupled to the antenna node, that communicates with a second electronic device. During operation, the interface circuit can provide, addressed to at least the second electronic device, a request for an enhanced RNR. The interface circuit can receive the enhanced RNR, where the enhanced RNR includes information specifying a non-collocated neighbor access-point identified by the second electronic device. Note that the enhanced RNR can be compatible with an IEEE 802.11bn standard. Moreover, the second electronic device can include a second access point and the electronic device can include a station or client that is associated with the second access point.

Furthermore, in a second group of embodiments, the second electronic device is described. The second electronic device can include: an antenna node communicatively coupled to an antenna; and an interface circuit, communicatively coupled to the antenna node, that communicates with the electronic device. During operation, the interface circuit can receive, associated with the electronic device, a request for an enhanced RNR. The interface circuit can provide, addressed to the electronic device, the enhanced RNR, where the enhanced RNR includes information specifying a non-collocated neighbor access-point of the second electronic device.

By communicating the enhanced RNR, these communication techniques can improve the situational awareness of the electronic device. For example, the enhanced RNR can inform the electronic device about a non-collocated neighbor access-point of the second electronic device. Consequently, the communication techniques can eliminate the need for a non-access-point stations to perform in-channel scans to discover non-collocated neighbor access points and/or access-point MLDs. Moreover, the communication techniques can provide additional information to the electronic device about, e.g., the reported neighbor access point(s). This can eliminate the need for a non-access-point station to perform one or more channel scans to obtain relevant information about the one or more access points reported in an RNR. Therefore, the communication techniques can reduce the time and power consumption of, e.g., a non-access point station. In these ways, the communication techniques can improve the user experience when using the electronic device and/or the second electronic device.

In the discussion that follows, a user can include: an individual, an organization, a company, a governmental agency, a for-profit business entity, a not-for-profit entity, or a group of one or more individuals.

Note that the communication techniques can be used during or with wired or wireless communication between electronic devices in accordance with a communication protocol, such as a communication protocol that is compatible with an IEEE 802.11 standard (which is sometimes referred to as Wi-Fi). However, the communication techniques can also be used with a wide variety of other communication protocols, and in electronic devices (such as portable electronic devices or mobile devices) that can incorporate multiple different radio access technologies (RATs) to provide connections through different wireless networks that offer different services and/or capabilities.

The electronic device and/or the second electronic device can include hardware and software to support a wireless personal area network (WPAN) according to a WPAN communication protocol, such as those standardized by the Bluetooth Special Interest Group and/or those developed by Apple (in Cupertino, California) that are referred to as an Apple Wireless Direct Link (AWDL). Moreover, the electronic device and/or the second electronic device can communicate via: a wireless wide area network (WWAN), a wireless metro area network (WMAN), a WLAN, near-field communication (NFC), a cellular-telephone or data network (such as using a third generation (3G) communication protocol, a fourth generation (4G) communication protocol, e.g., Long Term Evolution or LTE, LTE Advanced (LTE-A), a fifth generation (5G) communication protocol, or other present or future developed advanced cellular communication protocol) and/or another communication protocol. In some embodiments, the communication protocol includes a peer-to-peer communication technique.

The electronic device and/or the second electronic device, in some embodiments, can also operate as part of a wireless communication system, which can include a set of client devices, which can also be referred to as stations or client electronic devices, interconnected to an access point, e.g., as part of a WLAN, and/or to each other, e.g., as part of a WPAN and/or an ‘ad hoc’ wireless network, such as a Wi-Fi direct connection. In some embodiments, the client device can be any electronic device that is capable of communicating via a WLAN technology, e.g., in accordance with a WLAN communication protocol. Furthermore, in some embodiments, the WLAN technology can include a Wi-Fi (or more generically a WLAN) wireless communication subsystem or radio, and the Wi-Fi radio can implement an IEEE 802.11 technology, such as one or more of: IEEE 802.11a; IEEE 802.11b; IEEE 802.11g; IEEE 802.11-2007; IEEE 802.11n; IEEE 802.11-2012; IEEE 802.11-2016; IEEE 802.11ac; IEEE 802.11ax, IEEE 802.11ba, IEEE 802.11be, IEEE 802.11me, IEEE 802.11bn, IEEE 802.11bx, IEEE 802.11mf or other present or future developed IEEE 802.11 technologies.

Note that the electronic device and/or the second electronic device can use multi-user transmission (such as OFDMA) and/or multiple-input multiple-output (MIMO).

In some embodiments, the electronic device and/or the second electronic device can act as a communications hub that provides access to a WLAN and/or to a WWAN and, thus, to a wide variety of services that can be supported by various applications executing on the electronic device and/or the second electronic device. Thus, the electronic device and/or the second electronic device can include an ‘access point’ that communicates wirelessly with other electronic devices (such as using Wi-Fi), and that provides access to another network (such as the Internet) via IEEE 802.3 (which is sometimes referred to as ‘Ethernet’). Note that the access point can be a physical access point or a virtual or ‘software’ access point that is implemented on a computer or an electronic device. However, in other embodiments the electronic device and/or the second electronic device may not be an access point.

Additionally, it should be understood that the electronic devices described herein can be configured as multi-mode wireless communication devices that are also capable of communicating via different 3G and/or second generation (2G) RATs. In these scenarios, a multi-mode electronic device or UE can be configured to prefer attachment to LTE networks offering faster data rate throughput, as compared to other 3G legacy networks offering lower data rate throughputs. For example, in some implementations, a multi-mode electronic device is configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable. More generally, the electronic devices described herein can be capable of communicating with other present or future developed cellular-telephone technologies.

In accordance with various embodiments described herein, the terms ‘wireless communication device,’ ‘electronic device,’ ‘mobile device,’ ‘mobile station,’ ‘wireless station,’ ‘wireless access point,’ ‘station,’ ‘access point’ and ‘user equipment’ (UE) can be used herein to describe one or more consumer electronic devices that can be capable of performing procedures associated with various embodiments of the disclosure.

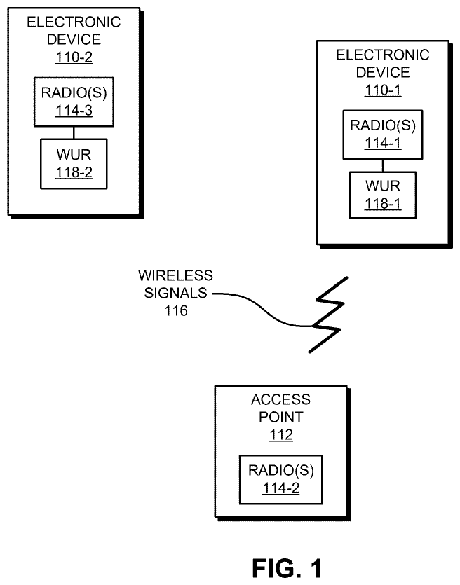

FIG. 1 presents a block diagram illustrating an example of electronic devices communicating wirelessly. Notably, one or more electronic devices 110 (such as a smartphone, a laptop computer, a notebook computer, a tablet, or another such electronic device) and access point 112 can communicate wirelessly in a WLAN using an IEEE 802.11 communication protocol. Thus, electronic devices 110 can be associated with or can have one or more connections with access point 112. For example, electronic devices 110 and access point 112 can wirelessly communicate while: detecting one another by scanning wireless channels, transmitting and receiving beacons or beacon frames on wireless channels, establishing connections (for example, by transmitting connect requests), and/or transmitting and receiving packets or frames (which can include the request and/or additional information, such as data, as payloads). Note that access point 112 can provide access to a network, such as the Internet, via an Ethernet protocol, and can be a physical access point or a virtual or ‘software’ access point that is implemented on a computer or an electronic device. In the discussion that follows, electronic devices 110 are sometimes referred to as ‘clients,’ ‘stations,’ or ‘recipient electronic devices.’

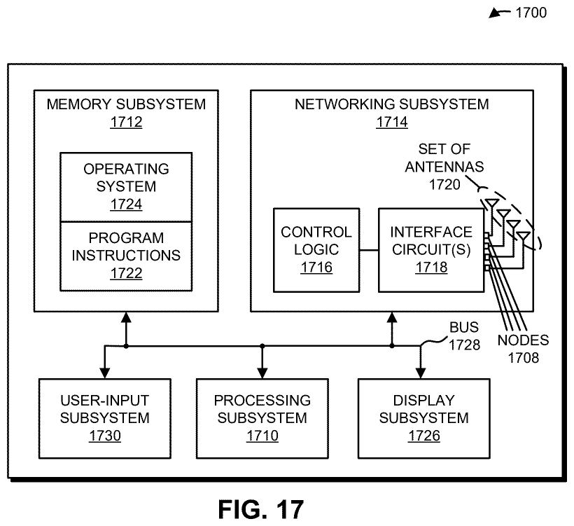

As described further below with reference to FIG. 17, electronic devices 110 and access point 112 can include subsystems, such as a networking subsystem, a memory subsystem, and a processor subsystem. In addition, electronic devices 110 and access point 112 can include radios 114 in the networking subsystems. More generally, electronic devices 110 and access point 112 can include (or can be included within) any electronic devices with networking subsystems that enable electronic devices 110 and access point 112, respectively, to wirelessly communicate with another electronic device. This can include transmitting beacon frames on wireless channels to enable the electronic devices to make initial contact with or to detect each other, followed by exchanging subsequent data/management frames (such as connect requests) to establish a connection, configure security options (e.g., IPSec), transmit and receive packets or frames via the connection, etc.

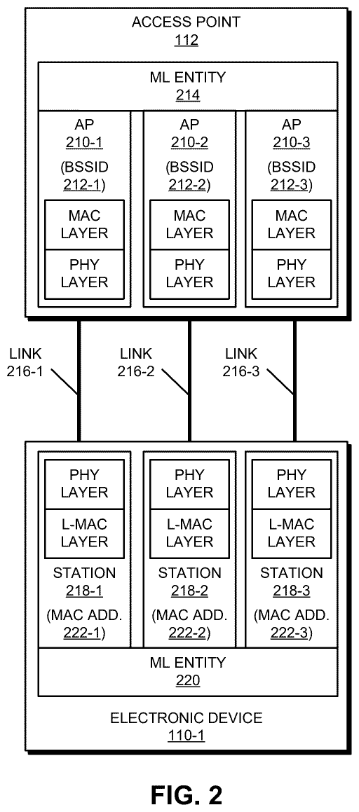

As can be seen in FIG. 1, wireless signals 116 (represented by a jagged line) are communicated by one or more radios 114-1 and 114-2 in electronic device 110-1 and access point 112, respectively. For example, as noted previously, electronic device 110-1 and access point 112 can exchange packets or frames using a Wi-Fi communication protocol in a WLAN. As illustrated further below with reference to FIGS. 2-14, one or more radios 114-1 can receive wireless signals 116 that are transmitted by one or more radios 114-2 via one or more links between electronic device 110-1 and access point 112. Alternatively, the one or more radios 114-1 can transmit wireless signals 116 that are received by the one or more radios 114-2.

In some embodiments, wireless signals 116 are communicated by one or more radios 114 in electronic devices 110 and access point 112, respectively. For example, one or more radios 114-1 and 114-3 can receive wireless signals 116 that are transmitted by one or more radios 114-2 via one or more links between electronic devices 110-1 and 110-2, and access point 112.

Note that the one or more radios 114-1 can consume additional power in a higher-power mode. If the one or more radios 114-1 remain in the higher-power mode even when they are not transmitting or receiving packets or frames, the power consumption of electronic device 110-1 can be needlessly increased. Consequently, electronic devices 110 can include wake-up radios (WURs) 118 that listen for and/or receive wake-up frames (and/or other wake-up communications), e.g., from access point 112. When a particular electronic device (such as electronic device 110-1) receives a wake-up frame, WUR 118-1 can selectively wake-up radio 114-1, e.g., by providing a wake-up signal that selectively transitions at least one of the one or more radios 114-1 from a lower-power mode to the higher-power mode.

IEEE 802.11be has proposed the use of multiple concurrent links between electronic devices, such as access point 112 and one or more of electronic device 110. For example, as shown in FIG. 2, which presents a block diagram illustrating an example of electronic devices communicating wirelessly, access point 112 can be an access point multi-link device (MLD) that includes multiple access points 210, which are cohosted or collocated in access point 112. In the present discussion, ‘cohosted’ or ‘collocated’ means that access points 210 are physically or virtually implemented in the same access point MLD, or are affiliated with the same access point MLD. Note that this meaning of ‘cohosted’ does not indicate that access points 210 have the same primary 20 MHz channel. Access points 210 can have associated basic service set identifiers (BSSIDs) 212, and media access control (MAC) and physical (PHY) layers (including separate radios, which can be included in the same or different integrated circuits). Note that access point 112 can have an ML entity 214 having an MLD MAC address, an ML identifier, a service set identifier (SSID), and that can provide security for access points 210.

Moreover, access points 210 can have different concurrent links 216 in different bands of frequencies (such as a link 216-1 with a link identifier 1 in a 2.4 GHz band of frequencies, a link 216-2 with a link identifier 2 in a 5 GHz band of frequencies and a link 216-3 with a link identifier 3 in a 6 GHz bands of frequencies) with stations 218 in at least electronic device 110-1, which is a non-access point MLD. These stations can have associated lower MAC and PHY layers (including separate radios, which can be included in the same or different integrated circuits). In addition, electronic device 110-1 can have an ML entity 220 having an MLD MAC address.

For example, the access point MLD can have three radios. One radio can operate on a 2.4 GHz band of frequencies, and the other radios can operate on the 5/6 GHz bands of frequencies. The access point MLD can create three access points 210, operating on a 2.4 GHz channel, a 5 GHz channel, and a 6 GHz channel respectively. The three access points 210 can operate independently, each of which has at least one BSS with different BSSIDs 212. (While FIG. 2 illustrates the access point MLD with three access points 210, more generally the access point MLD can include up to 15 access points with one or more access points in a given band of frequencies.) Moreover, each of the access points 210 can accommodate both legacy non-access point stations as well as non-access point MLD stations 218. Furthermore, each of access points 210 can transmit its own beacon frames using its own BSSID. Additionally, the access point MLD can have ML entity 214, identified by an MLD address (such as an MLD MAC address). This MAC address can be used to pair with ML entity 220 of the associated non-access point MLD stations 218.

Moreover, the non-access point MLD station (e.g., electronic device 110-1) can have two or three radios. One radio can operate on a 2.4 GHz band of frequencies, and the other radios can operate on the 5/6 GHz bands of frequencies. When the non-access point MLD establishes a ML association with the access point MLD, it can create up to three stations 218, each of which associates to one of access points 210 within the access point MLD. Each of stations 218 can have a different over-the-air MAC address 222. The non-access point MLD can also have ML entity 220, identified by another MLD address (such as another MLD MAC address). This MLD MAC address can be used to pair with ML entity 214 of the associated access point MLD.

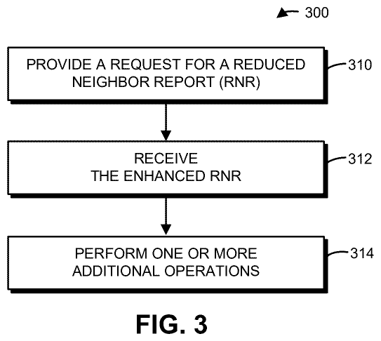

Referring back to FIG. 1, as noted previously, existing communication techniques may not provide information about non-collocated neighbor access points. In order to address these problems, as described further below with reference to FIGS. 3-16, access point 112 and/or electronic device 110-1 can perform the communication techniques.

Notably, access point 112 can provide, addressed to at least electronic device 110-1, a request for an enhanced RNR. This request can be received by electronic device 110-1. In response, electronic device 110-1 can provide, addressed to access point 112, the enhanced RNR. Moreover, access point can receive, from electronic device 110-1, the enhanced RNR. The enhanced RNR can include information specifying a non-collocated neighbor access-point identified by electronic device 110-1.

Note that the enhanced RNR can be compatible with an IEEE 802.11bn standard.

Furthermore, the enhanced RNR can specify a set of access points. The set of access points can include the non-collocated neighbor access point, and access point 112 can measure downlink RSSIs for one or more of the set of access points. Additionally, access point 112 can select a third access point to associate with based at least in part on the enhanced RNR and the measured downlink RSSI for the third access point. For example, access point 112 can measure: the downlink RSSI during exchange of an RTS frame and a CTS frame with the third access point; the downlink RSSI in less than 0.5 ms; the downlink RSSI using a physical preamble; and/or the downlink RSSI using an L-LTF field.

In some embodiments, the request for the enhanced RNR can be included in a probe request and the enhanced RNR can be included in a probe response. For example, the request for the enhanced RNR can be included in a request element in the probe request and the request element can include ‘201.’ Moreover, the probe request can include an extended capabilities element and the extended capabilities element can include bit 110 equal to ‘1.’

Furthermore, the probe request can include an SSID list or a short SSID list to request information about one or more SSIDs associated with one or more corresponding access points. Note that the probe request can include a time duration of the enhanced RNR.

Additionally, the information can be based at least in part on a type of the non-collocated neighbor access-point. For example, the type can include or can indicate which IEEE 802.11 standard(s) the non-collocated neighbor access-point is compatible.

In some embodiments, the enhanced RNR can include a TBTT information field type equal to ‘2.’

Note that the enhanced RNR can include one or more of: neighbor access-point dynamic attributes; MLD parameters; or MLMD parameters.

Moreover, the enhanced RNR can include one or more of: a physical layer version, physical layer capabilities, security support, or BSS load.

The disclosed communication techniques can facilitate improved situational awareness of access point 112 and/or electronic device 110-1. For example, the enhanced RNR can inform access point 112 about a non-collocated neighbor access-point of electronic device 110-1. This capability can reduce or eliminate a need for access point 112 (and/or electronic device 110-1) to perform in-channel scans to discover non-collocated neighbor access points and/or access-point MLDs. Moreover, the communication techniques can provide additional information to access point 112 and/or electronic device 110-1 about, e.g., the reported neighbor access point(s). This can eliminate the need for a non-access-point station to perform one or more channel scans to obtain relevant information about the one or more access points reported in an RNR. Therefore, the communication techniques can reduce the time and power consumption of, e.g., access point 112 and/or electronic device 110-1. Thus, the communication techniques can improve the user experience and customer satisfaction.

While the preceding discussion illustrated the communication of an enhanced RNR by electronic device 110-1 to access point 112, in other embodiments the roles of access point 112 and electronic device 110-1 can be reversed in the communication techniques. For example, electronic device 110-1 can include a second access point and access point 112 can be a second electronic device which is a station or client that is associated with the second access point.

Note that access point 112 and one or more electronic devices (such as electronic devices 110-1 and/or 110-2) can be compatible with an IEEE 802.11 standard that includes trigger-based channel access (such as IEEE 802.11ax). However, access point 112 and the one or more electronic devices can also communicate with one or more legacy electronic devices that are not compatible with the IEEE 802.11 standard (i.e., that do not use multi-user trigger-based channel access). In some embodiments, access point 112 and the one or more electronic devices use multi-user transmission (such as OFDMA). For example, the one or more radios 114-2 can provide one or more trigger frames for the one or more electronic devices. Moreover, in response to receiving the one or more trigger frames, the one or more radios 114-1 can provide one or more group or block acknowledgments to the one or more radios 114-2. For example, the one or more radios 114-1 can provide the one or more group acknowledgments during associated assigned time slot(s) and/or in an assigned channel(s) in the one or more group acknowledgments. However, in some embodiments one or more of electronic devices 110 can individually provide acknowledgments to the one or more radios 114-2. Thus, the one or more radios 114-1 (and, more generally, radios 114 in the electronic devices 110-1 and/or 110-2) can provide one or more acknowledgments to the one or more radios 114-2.

In the described embodiments, processing a packet or frame in one of electronic devices 110 and access point 112 includes: receiving wireless signals 116 encoding a packet or a frame; decoding/extracting the packet or frame from received wireless signals 116 to acquire the packet or frame; and processing the packet or frame to determine information contained in the packet or frame (such as data in the payload).

In general, the communication via the WLAN in the communication techniques can be characterized by a variety of communication-performance metrics. For example, the communication-performance metric can include one or more of: an RSSI, a data rate, a data rate for successful communication (which is sometimes referred to as a ‘throughput’), a latency, an error rate (such as a retry or resend rate), a mean-square error of equalized signals relative to an equalization target, inter-symbol interference, multipath interference, a signal-to-noise ratio (SNR), a width of an eye pattern, a ratio of a number of bytes successfully communicated during a predetermined or predefined time interval (such as a time interval between, e.g., 1 and 10 s) to an estimated maximum number of bytes that can be communicated in the predetermined or predefined time interval (the latter of which is sometimes referred to as the ‘capacity’ of a communication channel or link), and/or a ratio of an actual data rate to an estimated data rate (which is sometimes referred to as ‘utilization’).

Although we describe the network environment shown in FIG. 1 as an example, in alternative embodiments, different numbers and/or types of electronic devices can be present. For example, some embodiments can include more or fewer electronic devices. As another example, in other embodiments, different electronic devices can be transmitting and/or receiving packets or frames. In some embodiments, multiple links can be used during communication between electronic devices 110. Consequently, one of electronic devices 110 can perform operations in the communication techniques.

FIG. 3 presents a flow diagram illustrating an example method 300 for requesting an enhanced RNR. This method can be performed by an electronic device, such as access point 112 in FIG. 1. For example, method 300 can be implemented by an interface circuit in access point 112 in FIG. 1. Note that the communication between the electronic device and a second electronic device (such as electronic device 110-1 in FIG. 1, which can be a station or client that is associated with access point 112) can be compatible with an IEEE 802.11 communication protocol.

During operation, the electronic device provides, addressed to the second electronic device, a request for the enhanced RNR (operation 310).

The electronic receives, associated with the second electronic device, the enhanced RNR (operation 312), where the enhanced RNR includes information specifying a non-collocated neighbor access-point identified by the second electronic device.

Note that the enhanced RNR can be compatible with an IEEE 802.11bn standard.

Moreover, the second electronic device can include a second access point and the electronic device can include a station or client that is associated with the second access point.

In some embodiments, the request for the enhanced RNR can be included in a probe request and the enhanced RNR can be included in a probe response. For example, the request for the enhanced RNR can be included in a request element in the probe request and the request element can include ‘201.’ Moreover, the probe request can include an extended capabilities element and the extended capabilities element can include bit 110 equal to ‘1.’

Furthermore, the probe request can include an SSID list or a short SSID list to request information about one or more SSIDs associated with one or more corresponding access points. Note that the probe request can include a time duration of the enhanced RNR.

Additionally, the information can be based at least in part on a type of the non-collocated neighbor access-point. For example, the type can include or can indicate which IEEE 802.11 standard(s) the non-collocated neighbor access-point is compatible.

In some embodiments, the enhanced RNR can include a TBTT information field type equal to ‘2.’

Note that the enhanced RNR can include one or more of: neighbor access-point dynamic attributes; MLD parameters; or MLMD parameters.

Moreover, the enhanced RNR can include one or more of: a physical layer version, physical layer capabilities, security support, or BSS load.

In some embodiments, the electronic device can optionally perform one or more additional operations (operation 314). For example, the enhanced RNR can specify a set of access points. The set of access points can include the non-collocated neighbor access point, and the electronic device can measure downlink RSSIs for one or more of the set of access points. Additionally, the electronic device can select a third access point to associate with based at least in part on the enhanced RNR and the measured downlink RSSI for the third access point. For example, the electronic device can measure: the downlink RSSI during exchange of an RTS frame and a CTS frame with the third access point; the downlink RSSI in less than 0.5 ms; the downlink RSSI using a physical preamble; and/or the downlink RSSI using an L-LTF field.

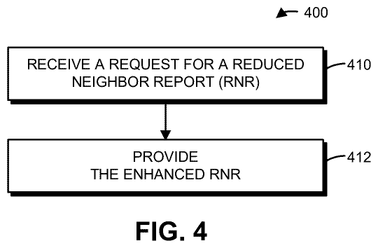

FIG. 4 presents a flow diagram illustrating an example method 400 for receiving an enhanced RNR. This method can be performed by a second electronic device, such as electronic device 110-1 in FIG. 1 (which can be a station or client that is associated with access point 112). For example, method 300 can be implemented by an interface circuit in electronic device 110-1 in FIG. 1. Note that the communication between the second electronic device and an electronic device (such as access point 112 in FIG. 1) can be compatible with an IEEE 802.11 communication protocol.

During operation, the second electronic device receives, associated with the electronic device, a request for the enhanced RNR (operation 410).

The second electronic provides, addressed to the electronic device, the enhanced RNR (operation 412), where the enhanced RNR includes information specifying a non-collocated neighbor access-point of the second electronic device.

In some embodiments of methods 300 (FIG. 3), and/or 400, there can be additional or fewer operations. Further, one or more different operations can be included. Moreover, the order of the operations can be changed, and/or two or more operations can be combined into a single operation or performed at least partially in parallel.

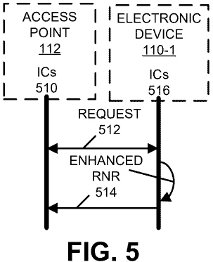

The communication techniques are further illustrated in FIG. 5, which presents a flow diagram illustrating an example of communication between electronic device 110-1 and access point 112. During operation, one or more interface circuits (or interface circuitry) 510 in access point 112 cab provide, addressed to electronic device 110-1, a request 512 for an enhanced RNR 514, where the enhanced RNR 514 can include information specifying a non-collocated neighbor access-point identified by electronic device 110-1.

This request can be received by one or more interface circuits (or interface circuitry) 516 in electronic device 110-1. The one or more interface circuits 516 can provide, addressed to access point 112, the enhanced RNR 514. Next, the one or more interface circuits 510 can receive the enhanced RNR 514.

While communication between the components in FIG. 5 is illustrated with unilateral or bilateral communication (e.g., lines having a single arrow or dual arrows), in general a given communication operation can be unilateral or bilateral. Moreover, while operations in FIG. 5 are illustrated as being sequential, in some embodiments at least some of the operations can be performed in parallel.

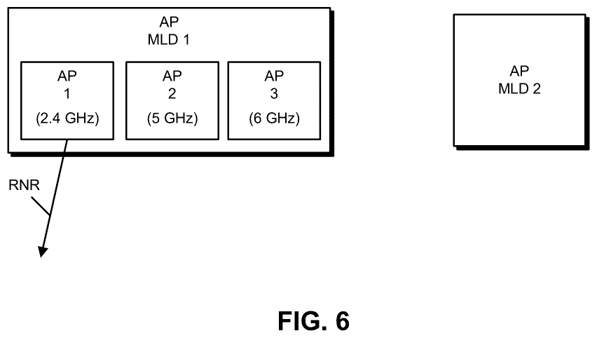

We now further describe embodiments of the disclosed communication techniques. As shown in FIG. 6, which presents a drawing illustrating existing communication between access points, an RNR is an out-of-band discovery tool used by an access point to communicate information about one or more neighboring access points. An RNR facilitates efficient access-point discovery by non-access-point stations. An RNR can be present in beacon or probe response frames (excluding multi-link-probe-response).

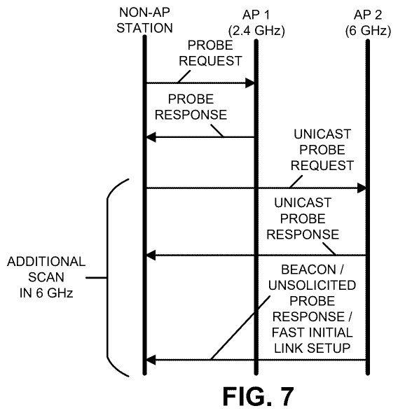

However, in practice, an RNR typically carries information regarding collocated access points affiliated with the same access-point multi-link device (MLD) (e.g., a single physical device that hosts multiple access points). Thus, an existing RNR may not include information about access point MLD 2. This is illustrated in FIG. 7, which presents a drawing illustrating existing communication between collocated access points 1 and 2 and a non-access point station. The probe response from access point 1 in the 2.4 GHz band of frequencies can include an RNR with information about collocated access point 2 operating in the 6 GHz band of frequencies. Alternatively, the non-access point station can passively receive a beacon, an unsolicited probe response, or a fast initial link setup frame from access point 2 in the 6 GHz band of frequencies.

Moreover, non-access-point stations will usually have to perform in-channel scans to discover non-collocated neighbor access points and/or access-point MLDs. Furthermore, a conventional RNR often contains only minimal information about the reported neighbor access point(s). Consequently, a non-access-point station may have to perform one or more channel scans to obtain relevant information about the one or more access points reported in an RNR. Channel scans are expensive for a non-access-point station to perform, both in terms of time and power consumption.

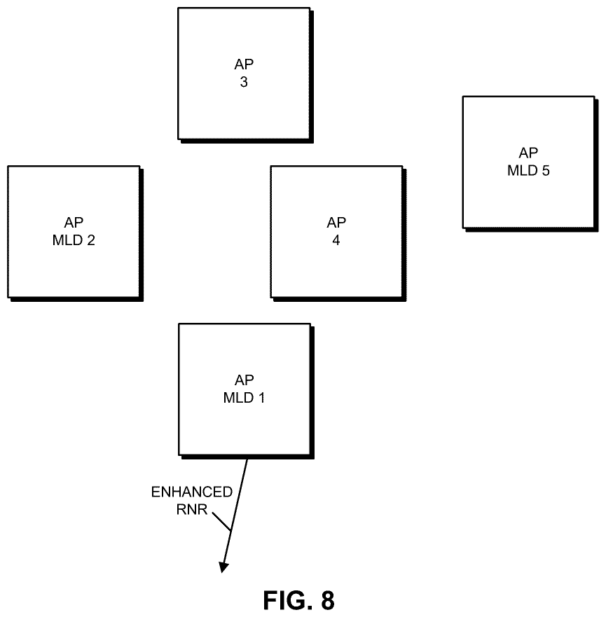

As shown in FIG. 8, which presents a drawing illustrating an example of communication between access points, the disclosed communication techniques provide an enhanced or special RNR (which is sometime referred to as ‘RNR+’). Notably, the enhanced RNR can include relevant information about one or more non-collocated neighboring access points (which can be different physical entities) and/or access-point MLDs, e.g., in the RNR element.

For example, the relevant information in the enhanced RNR about one or more reported access points can include one or more of the following attributes: basic service set identifier (BSSID); whether the reported access point is collocated with the reporting access point or is affiliated with the same access-point MLD as the reporting access point; a physical layer version (e.g., IEEE 802.11bn, IEEE 802.11be, IEEE 802.11ax, . . . pre-IEEE 802.11n); one or more physical layer capabilities (such as a maximum bandwidth, a maximum number of spatial streams or NSS, etc.); security support (such as Wi-Fi Protected Access 3 or WPA3, WPA2, open, etc.); BSS load; and/or downlink received signal strength indication or RSSI.

Note that the enhanced RNR can include in the RNR element one or more of the aforementioned attributes. This format can be addressed as or referred to as a ‘special RNR’ or an ‘enhanced RNR.’ A non-access-point station can perform one or more autonomous downlink RSSI measurements with the reported access points.

In some instances, the additional information can significantly increase the frame size. Notably, if an access point often (or always) includes full information about several non-collocated neighbor access-point MLDs, the information can proliferate RNR size and hence the airtime of the carrier frame (particularly beacon frames). The additional airtime utilized can increase congestion. Note that the current size of an RNR element defined in IEEE 802.11be for one access point in an access-point MLD is 19 bytes.

In the disclosed communication techniques, there can be efficient encoding of relevant information about one or more neighbor access points and/or access-point MLDs in an enhanced RNR. Notably, a new design of the RNR format can efficiently communicate relevant information about one or more neighbor access points and/or access-point MLDs. The inclusion of an enhanced RNR by the reporting access point can occur, e.g., in response to a request received from a non-access-point station. Stated differently, an enhanced RNR may not be included in beacon frames by default.

This approach can allow a non-access-point station to perform quick and informed access-point selection, e.g., for initial link setup, roaming, etc., without first having to execute multiple resource-intensive channel scans. For example, scans in all 2.4, 5, and 6 GHz band channels can take up to 5 seconds to complete. The disclosed communication techniques can provide a significant reduction both in associated time and power consumption. In the disclosed communication techniques, the additional time and power consumption associated with access-point discovery will only be incurred by a non-access-point station when it chooses to rely on channel scans to discover access points and/or access-point MLDs.

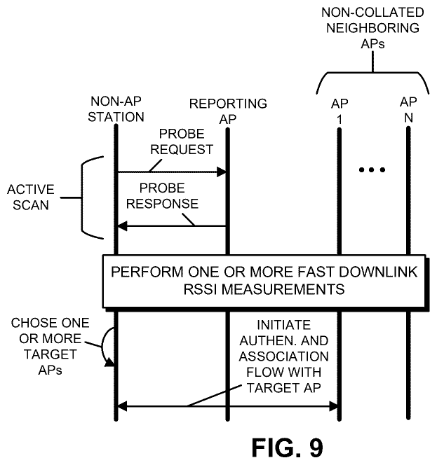

FIG. 9 presents a drawing illustrating an example of communication between access points in embodiments of the disclosed communication techniques. A non-access-point station can include a special RNR request, e.g., in a broadcast or unicast probe request provided to a reporting access point. In response, the reporting access point can provide a probe response utilizing the special or enhanced RNR response, which can include relevant information about one or more non-collocated access points. In some embodiments, instead of broadcast of unicast probe request, non-access-point station can provide a BSS transition management (BTM) query with the special RNR request, and instead of probe response, the reporting access point can provide a BTM response with the special RNR. Note that the time delay between receipt of the request frame and the providing of the response frame can be approximately tens of milliseconds.

The non-access-point station can perform a fast downlink RSSI measurement with one or more of the reported access points (the access points can be selected for an RSSI measurement based at least in part on the content included in the special RNR response).

Next, the non-access-point station can choose one or more of the access points as target access point(s) based at least in part on the special RNR response and/or the downlink RSSI measurements. Moreover, the non-access-point station can initiate an authentication and association flow with a target access point (such as access point 2).

Note that, using the disclosed communication techniques, the non-access-point station can be able to discover multiple neighbor access points, obtain relevant information about the respective neighbor access points, and/or select one or more candidate access points for association, e.g., using a single active channel-scan operation.

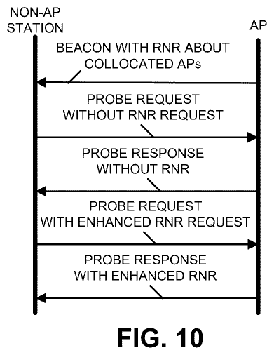

Moreover, FIG. 10 presents a drawing illustrating an example of communication between access points. In FIG. 10, a unicast or broadcast probe request can include a request for a special or enhanced RNR and, when supported, a subsequent unicast or broadcast probe response can include the special or enhanced RNR.

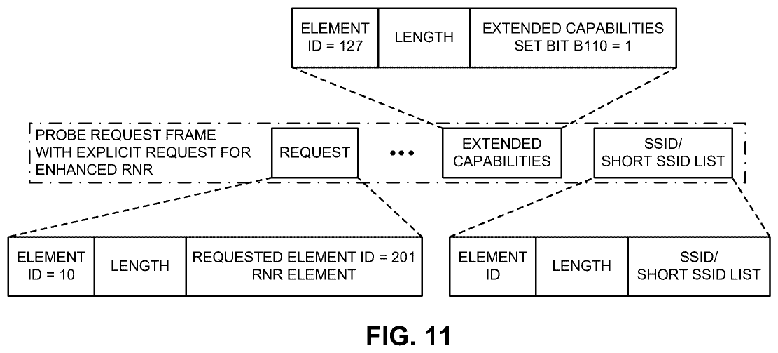

Furthermore, FIG. 11 presents a drawing illustrating an example of a probe-request frame. A request for a special RNR (e.g., at the 3rd location in order in the probe request frame) can be specified by a station by: including a ‘request’ element in a probe request frame; and/or specifying ‘201’ in the Request Element Identifiers Subfield (the element identifier of the RNR is 201). In practice, the frequency with which a station can request an RNR element in a probe request frame can be low. Consequently, when an ultra-high-resolution (UHR) access point receives this request, it can treat the request as a request for a special RNR and can respond accordingly.

In some embodiments, a station can include an ‘Extended Capabilities’ element in the probe request frame (e.g., at the 9th location in order in the probe request frame) and can set a predetermined bit, e.g., bit B110, to ‘1’ to indicate that the station is requesting/capable of receiving a special RNR. Alternatively or additionally, the station can optionally include an ‘SSID List’ or ‘Short SSID List’ element (e.g., at the 10th or 37th location in order in the probe request frame) to request information about one or more access points belonging (e.g., only) to the specified SSID(s) for which information is requested. Note that the access point can include the special RNR in the probe response frame when the above conditions are satisfied in the probe request frame transmitted by station. When the one or more conditions for sending the special RNR are not met, it can be omitted to reduce use of the medium or communication channel.

Furthermore, the special or enhanced RNR information format (Target Beacon Transmission Time or TBTT Information Field Type equal to ‘2’) can include one or more of the following attributes about the reported neighbor access point and/or access-point MLD: BSSID (e.g., 6 bytes); short SSID (e.g., 4 bytes); neighbor access-point static attributes (e.g., 2 bytes); neighbor access-point dynamic attributes (e.g., 3 bytes); MLD parameters (e.g., 1 byte); and/or multi-link mobility domain (MLMD) parameters (e.g., 1 byte). For example, the neighbor access-point static attributes can include: a collocated access point (such as the reported access point is collocated with the reporting access point, e.g., 1 bit); multiple BSSID (the reported access point is part of a multiple BSSID set); Internet Protocol or IP address continuity (a station can maintain the same IP address when moving from a reporting access point to a reported access point); security mode supported (e.g., WPA3, WPA2, WPA-TKIP and/or open, which can be indicated using 8 bits); an IEEE 802.11 physical layer version (IEEE 802.11bn, IEEE 802.11be, IEEE 802.11ax, IEEE 802.11ac, IEEE 802.11n, or pre-IEEE 802.11n, which can be indicated using 4 bits); a reported access-point device class (which can be applicable only in 6 GHz channels, such as standard power or SP, low power indoor or LPI or composite); and/or a reserved field (e.g., 3 bits). Moreover, neighbor access-point dynamic attributes can include one or more of: a highest BSS operating bandwidth (e.g., 320 MHz, 160 MHz, 80 MHz, 40 MHz, or 20 MHz, which can be indicated using 4 bits); a highest NSS (e.g., 4 bits); a BSS load/channel utilization (e.g., 4 bits); a timeliness of information (such as a difference in a time synchronization function or TSF between information collection and transmission of a special RNR, e.g., 8 bits); and/or a reserved field (e.g., 4 bits). Furthermore, MLD parameters can include: an access-point MLD identifier (e.g., 8 bits). Additionally, MLMD parameters can include: an access-point MLMD identifier (e.g., 8 bits). Note that an MLMD can include a virtual mobility domain, which can include non-collocated access points and/or MLDs that are aggregated together (e.g., over the air or via wire) into the MLMD.

Moreover, the type of reported neighbor access point and fields that can be included in a TBTT Information Set. Note that the TBTT Information Field Type can be set equal to ‘2’ in the TBTT Information Header.

For a non-MLD access point (e.g., pre-Wi-Fi 7), the TBTT Information Set can include one or more of: the BSSID, the short SSID, neighbor access-point static attributes, and/or neighbor access-point dynamic attributes, with a length of, e.g., 15 bytes. Moreover, for an access point affiliated with the same access-point MLD as the reporting access point, the TBTT Information Set can include one or more of: the BSSID, the MLD parameters, and/or neighbor access-point dynamic attributes, with a length of, e.g., 11 bytes. For an access point affiliated with a different Wi-Fi 7 access-point MLD 2 (and no other access point affiliated with access-point MLD 2 reported in the RNR), the TBTT Information Set can include one or more of: the BSSID, the short SSID, MLD parameters, neighbor access-point static attributes, and/or neighbor access-point dynamic attributes, with a length of, e.g., 16 bytes. Furthermore, for an access point affiliated with a different Wi-Fi 7 access-point MLD 2 in the RNR (and where another access point affiliated with access-point MLD 2 already reported in the RNR), the TBTT Information Set can include one or more of: the BSSID, MLD parameters, and/or neighbor access-point dynamic attributes, with a length of, e.g., 11 bytes. For an access point affiliated with a different Wi-Fi 8 access-point MLD 2 (and no other access point affiliated with access-point MLD 2 reported in the RNR), the TBTT Information Set can include one or more of: the BSSID, the short SSID, MLMD parameters, MLD parameters, neighbor access-point static attributes, and/or neighbor access-point dynamic attributes, with a length of, e.g., 17 bytes. Additionally, for an access point affiliated with a different Wi-Fi 8 access-point MLD 2 (where another access point affiliated with access-point MLD 2 is already reported in the RNR), the TBTT Information Set can include one or more of: the BSSID, MLMD parameters, MLD parameters, and/or neighbor access-point dynamic attributes, with a length of, e.g., 12 bytes.

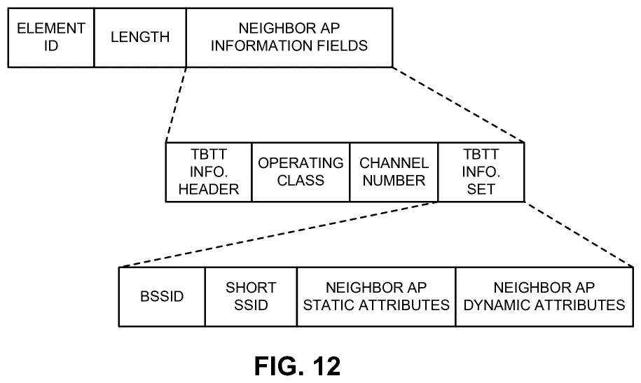

Additionally, FIG. 12 presents a drawing illustrating an example of an RNR element for non-collocated neighbor pre-extremely-high-throughput (EHT) access point(s). Notably, the RNR element transmitted by the ‘reporting access point’ (which can be affiliated with a reporting UHR access-point MLD 1) can contain information about one or more access points affiliated with one or more non-collocated neighbor pre-EHT access points, such as access point 2. Note that in this case, the TBTT Information Field Type can be equal to ‘2’ and the TBTT Information Length can be equal to 15 bytes. In other implementations, other values can be used.

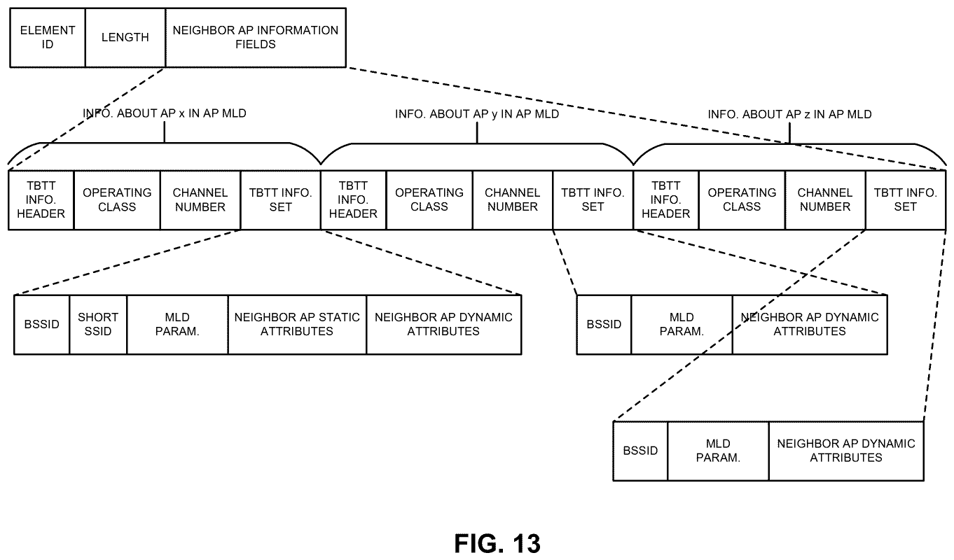

FIG. 13 presents a drawing illustrating an example of an RNR element for non-collocated neighbor EHT access points MLDs, such as UHR access-point MLD1 and EHT access-point MLD 2 (which may include access point x, access point y and access point z). Notably, the RNR element transmitted by a ‘reporting access point’ (affiliated with UHR access-point MLD 1) can contain information about one or more access points affiliated with a non-collocated neighbor EHT access-point MLD 2. For access point x in access-point MLD 2, in some implementations, the TBTT Information Field Type can be equal to ‘2’ and the TBTT Information Length can be equal to 16 bytes. In other implementations, other values can be used. For access point y in access-point MLD 2, in some implementations, the TBTT Information Field Type can be equal to ‘2’ and the TBTT Information Length can be equal to 11 bytes. In other implementations, other values can be used. For access point z in access-point MLD 2, in some implementations, the TBTT Information Field Type can be equal to ‘2’ and the TBTT Information Length can be equal to 11 bytes. In other implementations, other values can be used. Note that access points affiliated with the same access-point MLD can have the same access-point MLD identifier (such as access-point MLD identifier equal to ‘2’) in the MLD parameters. Because the SSID and the static attributes are the same for the access points, this information can be reported for only one access point, e.g., access point x.

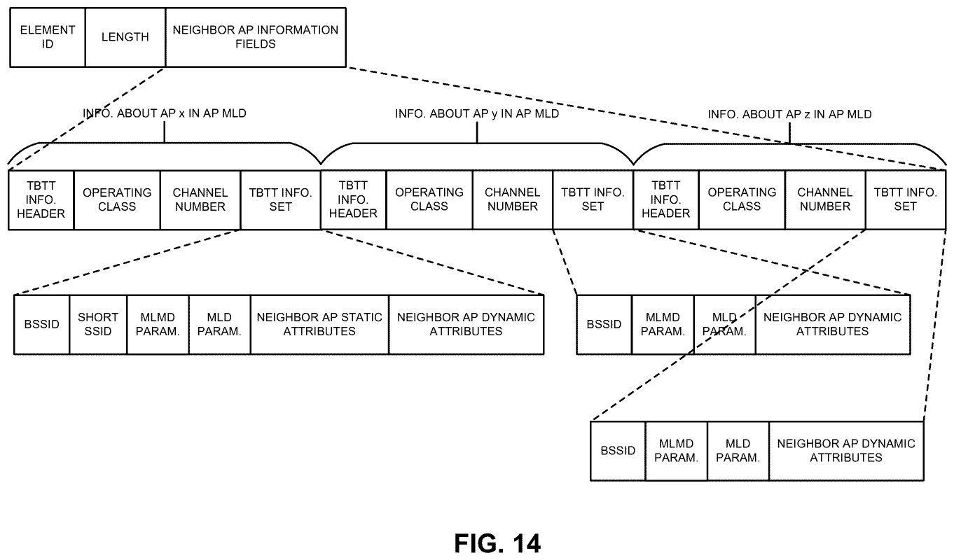

FIG. 14 presents a drawing illustrating an example of an RNR element for non-collocated neighbor EHR access point MLDs, such as UHR access-point MLD1 and UHR access-point MLD 2 (which may include access point x, access point y and access point z). The RNR element transmitted by a ‘reporting access point’ (affiliated with UHR access-point MLD 1) can contain information about one or more access points affiliated with a non-collocated neighbor EHR access-point MLD 2. For access point x, in some implementations, the TBTT Information Field Type can be equal to ‘2’ and the TBTT Information Length can be equal to 17 bytes. In other implementations, other values can be used. Furthermore, for access point y, in some implementations, the TBTT Information Field Type can be equal to ‘2’ and the TBTT Information Length can be equal to 12 bytes. In other implementations, other values can be used. For access point z, in some implementations, the TBTT Information Field Type can be equal to ‘2’ and the TBTT Information Length can be equal to 12 bytes. In other implementations, other values can be used. Note that access points affiliated with the same access-point MLD can have the same access-point MLD identifier (such as access-point MLD identifier equal to ‘2’). Also note that the access-point MLMD identifier in the MLMD parameters can be, e.g., ‘0’ when access-point MLD 2 is affiliated with the same MLMD as the reporting access point.

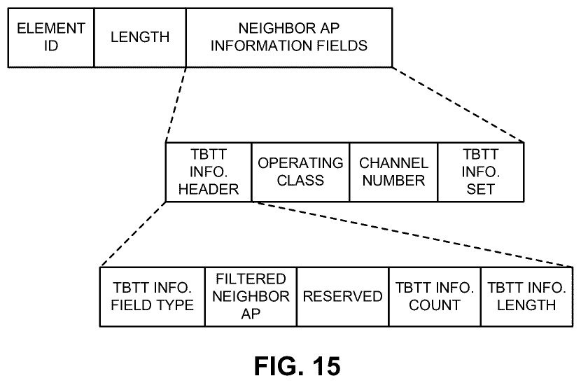

In some embodiments, the presence of one or more neighbor access points may not be included in the RNR. Notably, as shown in FIG. 15, which presents a drawing illustrating an example of an RNR element, in some embodiments the reporting access point may not include in the special RNR information about all neighbor access points and/or access-point MLDs. The decision to include (or not include) the details about a neighbor access point can be made by the reporting access point. For example, the reporting access point can restrict (or limit) the number of reported access points in the special RNR, e.g., to manage the size of the frame carrying the special RNR. It can be desirable to have an indication from the reporting access point about the presence of one or more other neighbor access points and/or access-point MLDs that have not been identified in the special RNR. In some embodiments, this information or signaling can be included in the TBTT Information Header Subfield. Notably, a reserved subfield can be renamed as ‘all access points included.’ This subfield can be set to, e.g., ‘1’ when all neighboring access points known to the reporting access point and operating in the primary channel (as identified by their operating class and channel number) are included in the TBTT Information Set. Otherwise, the subfield can be set to ‘0.’ In other implementations, other values can be used.

Note that a station can provide a probe request that indicates a request for a special RNR. In response, the access point can provide a probe response that includes the special RNR for all the access points included. However, the bit can be set to, e.g., ‘0’ for one or more channels. In response the station can follow different options. For example, it can perform one or more autonomous scans in one or more of the channels for which the all access points included bit was set to, e.g., ‘0’ in the special RNR. Through the one or more scans, the station can obtain information about one or more access points not included in the special RNR. Alternatively, the station can send another probe request with an indication for special RNR, e.g., to receive information about one or more unreported neighbor access points from one or more other sources.

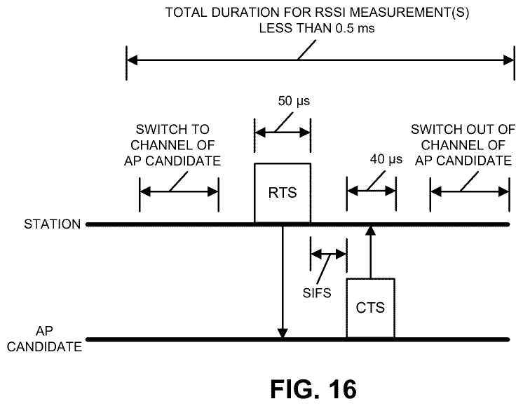

FIG. 16 presents a drawing illustrating an example of an RSSI measurement. Notably, FIG. 16 shows techniques for fast active RSSI measurements using RTS-CTS. The special RNR exchange can provide static and/or dynamic information about one or more neighboring access points to a station, e.g., from the reporting access point. However, the RSSI between the reported access point(s) and the station may remain unknown. Accordingly, in some implementations, RTS-CTS frames are used to enable rapid measurement of downlink RSSI from one or more of the reported access points to the station. RTS-CTS frames are class-1 control frames that can be exchanged between a station and an unassociated (and unauthenticated) access point. For example, a station can send an RTS to a candidate access point. The station can measure the RSSI of the candidate access point to the station using the CTS response. This approach can provide a simple framework for downlink RSSI measurement that is supported in current IEEE 802.11 standards. The overhead of this type of RSSI measurement also can be low. Moreover, this approach can provide similar RSSI measurement accuracy as beacon and/or probe-response frames. For example, the RSSI can be measured over the preamble (L-LTF field) of the frames (in the physical header) and these frames are transmitted with robust rates. A total duration for the RSSI measurements can be less than 0.5 ms.

In some embodiments, the special or enhanced RNR may indicate security protocol support (such as Wi-Fi Protected Access 2 or WPA2, Wi-Fi Protected Access 3 or WPA3, etc.) of each neighbor access point in the special or enhanced RNR. For example, the corresponding Authentication and Key Management (AKM) Suite selector(s) in a Robust Security Network Information Element (RSNE) for WPA2, WPA3, etc. supported by each reported access point can be indicated in an enhanced RNR (such as by using four octets). This information can be used by a client to rank roaming and auto-join candidate access points or networks. Note that the ranking can use an order of preference of: Enterprise greater than Pre-Shared Key (PSK), which is greater than Open, WPA3, which is greater than WPA2 which is greater than WPA, and which is greater than Wired Equivalent Privacy (WEP).

Thus, a unique identifier (such as a named security protocol identifier) can be assigned that identifies an AKM Suite supported by the reported access point. For example, a bitmap (e.g., three octets), such as a Security Protocol Support Bitmap, can be included in the enhanced RNR for each reported access point. A ‘1’1 can be set for each bit position (starting from the least significant bit) corresponding to the Security Protocol identifier supported by the reported access point. For example, WPA-Enterprise or WPA2-Enterprise (IEEE 802.1X) can have a security protocol identifier of ‘1,’ WPA-Personal or WPA2-Personal (PSK) can have a security protocol identifier of ‘2,’ WPA2-Enterprise with fast transition (FT) can have a security protocol identifier of ‘3,’ WPA2-Personal with FT can have a security protocol identifier of ‘4,’ WPA3-Personal (SAE) can have a security protocol identifier of ‘5,’ WPA3-Enterprise (SAE) can have a security protocol identifier of ‘6,’ WPA3-Personal with FT can have a security protocol identifier of ‘7,’ WPA3-Enterprise with FT can have a security protocol identifier of ‘8,’ WPA3-Enterprise Suite-B (192 bit) can have a security protocol identifier of ‘9,’ WPA3-Enterprise Suite-B (192 bit) with FT can have a security protocol identifier of ‘10,’ and Opportunistic Wireless Encryption (OWE) can have a security protocol identifier of ‘11.’ Thus, the Security Protocol Support Bitmap can be set as ‘0x8 0x8 01010101.’ This indicates that the reported access point supports WPA2-Enterprise (with and without FT) and WPA3-Personal (with and without FT). Note that the Security Protocol Support Bitmap can be set as all ‘0s’ if the reported access point does not support any of the listed security protocols. In some embodiments, the requesting station can deduce the AKM Suite(s) supported by the reported access point based at least in part on the bitmap.

In some embodiments, the enhanced RNR can indicate the freshness of the access-point information. For example, when information about non-collocated access points is collected at different times, it can be desirable for a non-access point station to know when information about a give access point was collected along with the relevant attributes. When the information is old, it may not be useful, especially for dynamic attributes such as BSS load.

Consequently, in some embodiments, a ‘timestamp of information collection’ attribute can be added for each reported access point in the enhanced RNR. The timestamp of information collection can be the latest time synchronization function (TSF) time at which one or more of the dynamic attributes of the reported access point were reported/updated, such as: the BSS operating bandwidth; the BSS load and station count; association disallowed; and/or a BSS parameters change count. In some embodiments, a reporting access point can collect information of neighbor access points: over-the-distribution system or DS (which may assume that a central controller that stores relevant information, including dynamic attributes, of neighbor access points); and/or over-the-air (in which a reporting access point can be equipped with scan radios that can be used to listen to beacon and/or probe response frames transmitted by neighbor access points).

Over-the-DS flow can enable fast and accurate information retrieval. It may be reasonable to assume that the controller has the latest information about neighbor access points. For example, whenever an access point has an update to any of its attributes, it may push the update up to the controller. The reporting access point can retrieve information about neighbor access points by polling the controller. It can specify the TSF corresponding to the latest retrieval as the timestamp of information collection.

Moreover, over-the-air flow can assume that the reporting access point performs off-channel scans to retrieve information about neighbor access points. Note that the access points may include low-power radio(s) to facilitate such scans (active or passive). The dynamic attributes of interest regarding neighbor access points can present in the following elements, which may be present in beacon and/or probe response frames transmitted by neighbor access points: the BSS operating bandwidth, e.g., in high throughput or very high throughput fields; the BSS load and station count, e.g., in the BSS load element; association disallowed, e.g., in the OCE information element or a vendor-specific information element; and/or a BSS parameters change count, e.g., in a multi-link element and/or an RNR. These elements can be present in beacon and/or probe response frames transmitted by neighbor access point(s), but can also be carried in proprietary frame exchanges between neighbor access point(s) and the reporting access points.

Note that the reporting access point can specify the timestamp of information collection for a neighbor access point as the TSF time at which the latest update was received or collected for that neighbor access point, which may affect one or more of the dynamic attributes.

In case of over-the-DS retrieval, all of the dynamic attributes pertaining to a neighbor access point can be pulled at the same time from the controller, so that there is a synchronous update of the attributes. Alternatively, in case of over-the-air retrieval, the dynamic attributes can be updated asynchronously. Consequently, different dynamic attributes can be updated at different times and, thus, all of the dynamic attributes may not be carried in a single update from a neighbor access point.

In order to address these challenges, the reporting access point may specify a bitmap of dynamic attributes (which can be referred to as an ‘updated attributes bitmap’) for each reported access point to identify the attributes that were modified in the latest update. The bitmap can be 4 bits long (one bit for each dynamic attribute). When a bit position is set as ‘1,’ the attribute corresponding to that bit position can carry the value as received in the latest update. For example, an updated attributes bitmap of ‘1011’ can indicate that the attributes that were most recently updated are: BSS Operating bandwidth, BSS load, and BSS Parameter Change Count. Note that the time of the most recent update can be carried in or conveyed by the timestamp of information collection.

In some embodiments, the enhanced RNR can indicate a time delay between an enhanced RNR request and response (such as an upper bound on the time delay). The goal can be that a station receives information about neighbor non-collocated access points through the reporting access point without incurring a significant delay. Stated differently, the time delay between request for an enhanced RNR and a response may not be inordinately large. Note that, as the delay increases, the benefits of an enhanced RNR may be diluted because it will incur a similar time overhead as a station performing autonomous channel scans.

In order to motivate a reduction in the response time, an upper bound on the time delay between a request for an enhanced RNR and a response frame may be included in the request. For example, an upper bound on this delay can be on the order of milliseconds, such as less than 10 ms. This delay may be specified in an IEEE 802.11 standard or may be tested in the Wi-Fi Alliance (of Austin, Texas).

When the delay is small, the reporting access point can provide cached information about neighbor access point(s) to meet the delay bound. This may be acceptable because static information about neighbor access points(s) is typically useful and likely not changed over time. Note that, when the dynamic information about neighbor access point(s) is indeed old, it can be reflected in the timestamp of information collection field. In some embodiments, a client can perform appropriate actions or remedial actions based at least in part on the timestamp. For example, the client can perform directed scans for those neighbor access points(s) for which the information is old, etc.

Moreover, in some embodiments, an enhanced RNR format for neighbor access point and/or access-point MLD discovery and ranking can be indicated by a TBTT information field type of ‘2.’ This enhanced RNR format can include the following attributes about a neighbor access point and/or access point MLD: a TBTT offset (e.g., one byte); a BSSID (e.g., six bytes); a short selective service identifier (e.g., four bytes); reported access-point static attributes (e.g., six bytes); reported access-point dynamic attributes (e.g., six bytes); MLD parameters (e.g., one byte);

and/or MLMD parameters (e.g., one byte). The reported access-point static attributes can include: a collocated access point; a physical layer type; security protocol support; Internet Protocol (IP) address continuity; a highest modulation and coding scheme (MCS); a highest number of spatial streams (NSS); an optional unsolicited probe response or UPR active (for the 6 GHz band of frequencies); and/or a 20 MHz power spectral density or PSD (for the 6 GHz band of frequencies).

Furthermore, the reported access-point dynamic attributes can include: the timestamp of information collection; an updated attributes bitmap; a BSS operating bandwidth; a BSS load and station count; association disallowed; and/or a BSS parameters change count. The MLD parameters can include an access-point MLD identifier. Additionally, the MLMD parameters can include a single mobility domain (SMD) identifier and/or an MLMD identifier.

In some embodiments, the communication techniques can be implemented in a physical layer and/or a MAC layer.

Note that the formats of packets or frames communicated during the communication techniques can include more or fewer bits, subfields or fields. Alternatively or additionally, the position of information in these packets or frames can be changed. Thus, the order of the subfields or fields can be changed.

While the preceding embodiments illustrate embodiments of the communication techniques using frequency sub-bands, in other embodiments the communication techniques can involve the concurrent use of different temporal slots, and/or or a combination of different frequency sub-bands, different frequency bands and/or different temporal slots. In some embodiments, the communication techniques can use OFDMA.

Moreover, while the preceding embodiments illustrated the use of Wi-Fi during the communication techniques, in other embodiments of the communication techniques Bluetooth or Bluetooth Low Energy is used to communicate at least a portion of the information in the communication techniques. Furthermore, the information communicated in the communication techniques can be communicated or can occur in one or more frequency bands, including: 900 MHz, a 2.4 GHz frequency band, a 5 GHz frequency band, a 6 GHz frequency band, a 60 GHz frequency band, a Citizens Broadband Radio Service (CBRS) frequency band, a band of frequencies used by LTE or another data communication protocol, etc.

As described herein, aspects of the present technology can include the gathering and use of data available from various sources, e.g., to improve or enhance functionality. The present disclosure contemplates that in some instances, this gathered data can include personal information data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital signs measurements, medication information, exercise information), date of birth, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configurable to allow users to selectively “opt in” or “opt out” of participation in the collection of personal information data, e.g., during registration for services or anytime thereafter. In addition to providing “opt in” and “opt out” options, the present disclosure contemplates providing notifications relating to the access or use of personal information. For instance, a user can be notified upon downloading an app that their personal information data will be accessed and reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure can broadly cover use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 17 presents a block diagram of an electronic device 1700 (which can be a cellular telephone, a smartwatch, an access point, a wireless speaker, an IoT device, another electronic device, etc.) in accordance with some embodiments. This electronic device includes processing subsystem 1710, memory subsystem 1712 and networking subsystem 1714.

Processing subsystem 1710 includes one or more devices configured to perform computational operations. For example, processing subsystem 1710 can include one or more microprocessors, application-specific integrated circuits (ASICs), microcontrollers, graphics processing units (GPUs), programmable-logic devices, and/or one or more digital signal processors (DSPs).

Memory subsystem 1712 includes one or more devices for storing data and/or instructions for processing subsystem 1710, and/or networking subsystem 1714. For example, memory subsystem 1712 can include dynamic random access memory (DRAM), static random access memory (SRAM), a read-only memory (ROM), flash memory, and/or other types of memory. In some embodiments, instructions for processing subsystem 1710 in memory subsystem 1712 include: program instructions or sets of instructions (such as program instructions 1722 or operating system 1724), which can be executed by processing subsystem 1710. For example, a ROM can store programs, utilities or processes to be executed in a non-volatile manner, and DRAM can provide volatile data storage, and can store instructions related to the operation of electronic device 1700. Note that the one or more computer programs can constitute a computer-program mechanism, a computer-readable storage medium or software. Moreover, instructions in the various modules in memory subsystem 1712 can be implemented in: a high-level procedural language, an object-oriented programming language, and/or in an assembly or machine language. Furthermore, the programming language can be compiled or interpreted, e.g., configurable or configured (which can be used interchangeably in this discussion), to be executed by processing subsystem 1710. In some embodiments, the one or more computer programs are distributed over a network-coupled computer system so that the one or more computer programs are stored and executed in a distributed manner.

In addition, memory subsystem 1712 can include mechanisms for controlling access to the memory. In some embodiments, memory subsystem 1712 includes a memory hierarchy that includes one or more caches coupled to a memory in electronic device 1700. In some of these embodiments, one or more of the caches is located in processing subsystem 1710.

In some embodiments, memory subsystem 1712 is coupled to one or more high-capacity mass-storage devices (not shown). For example, memory subsystem 1712 can be coupled to a magnetic or optical drive, a solid-state drive, or another type of mass-storage device. In these embodiments, memory subsystem 1712 can be used by electronic device 1700 as fast-access storage for often-used data, while the mass-storage device is used to store less frequently used data.

Networking subsystem 1714 includes one or more devices configured to couple to and communicate on a wired and/or wireless network (i.e., to perform network operations), such as: control logic 1716, one or more interface circuits (or interface circuitry) 1718 and a set of antennas 1720 (or antenna elements) in an adaptive array that can be selectively turned on and/or off by control logic 1716 to create a variety of optional antenna patterns or ‘beam patterns.’ Alternatively, instead of the set of antennas, in some embodiments electronic device 1700 includes one or more nodes 1708, e.g., a pad or a connector, which can be coupled to the set of antennas 1720. Thus, electronic device 1700 may or may not include the set of antennas 1720.

For example, networking subsystem 1714 can include a Bluetooth™ networking system, a cellular networking system (e.g., a 3G/4G/5G network such as UMTS, LTE, etc.), a universal serial bus (USB) networking system, a networking system based on the standards described in IEEE 802.12 (e.g., a Wi-Fi® networking system), an Ethernet networking system, and/or another networking system.

In some embodiments, networking subsystem 1714 includes one or more radios, such as a wake-up radio that is used to receive wake-up frames and wake-up beacons, and a main radio that is used to transmit and/or receive frames or packets during a normal operation mode. The wake-up radio and the main radio can be implemented separately (such as using discrete components or separate integrated circuits) or in a common integrated circuit.

Networking subsystem 1714 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1700 can use the mechanisms in networking subsystem 1714 for performing simple wireless communication between the electronic devices, e.g., transmitting advertising or frame frames and/or scanning for advertising frames transmitted by other electronic devices.

Within electronic device 1700, processing subsystem 1710, memory subsystem 1712 and networking subsystem 1714 are coupled together using bus 1728 that facilitates data transfer between these components. Bus 1728 can include an electrical, optical, and/or electro-optical connection that the subsystems can use to communicate commands and data among one another. Although only one bus 1728 is shown for clarity, different embodiments can include a different number or configuration of electrical, optical, and/or electro-optical connections among the subsystems.

In some embodiments, electronic device 1700 includes a display subsystem 1726 for displaying information on a display, which can include a display driver and the display, such as a liquid-crystal display, a multi-touch touchscreen, etc. Display subsystem 1726 can be controlled by processing subsystem 1710 to display information to a user (e.g., information relating to incoming, outgoing, or an active communication session).

Moreover, electronic device 1700 can also include a user-input subsystem 1730 that allows a user of the electronic device 1700 to interact with electronic device 1700. For example, user-input subsystem 1730 can take a variety of forms, such as: a button, keypad, dial, touch screen, audio input interface, visual/image capture input interface, input in the form of sensor data, etc.

Electronic device 1700 can be (or can be included in) any electronic device with at least one network interface. For example, electronic device 1700 can include: a cellular telephone or a smartphone, a tablet computer, a laptop computer, a notebook computer, a personal or desktop computer, a netbook computer, a media player device, a wireless speaker, an IoT device, an electronic book device, a MiFi® device, a smartwatch, a wearable computing device, a portable computing device, a consumer-electronic device, a vehicle, a door, a window, a portal, an access point, a router, a switch, communication equipment, test equipment, as well as any other type of electronic computing device having wireless communication capability that can include communication via one or more wireless communication protocols.

Although specific components are used to describe electronic device 1700, in alternative embodiments, different components and/or subsystems can be present in electronic device 1700. For example, electronic device 1700 can include one or more additional processing subsystems, memory subsystems, networking subsystems, and/or display subsystems.

Additionally, one or more of the subsystems may not be present in electronic device 1700.

Moreover, in some embodiments, electronic device 1700 can include one or more additional subsystems that are not shown in FIG. 17. In some embodiments, electronic device can include an analysis subsystem that performs at least some of the operations in the communication techniques. Also, although separate subsystems are shown in FIG. 17, in some embodiments some or all of a given subsystem or component can be integrated into one or more of the other subsystems or component(s) in electronic device 1700. For example, in some embodiments program instructions 1722 are included in operating system 1724 and/or control logic 1716 is included in the one or more interface circuits 1718.

Moreover, the circuits and components in electronic device 1700 can be implemented using any combination of analog and/or digital circuitry, including: bipolar, PMOS and/or NMOS gates or transistors. Furthermore, signals in these embodiments can include digital signals that have approximately discrete values and/or analog signals that have continuous values. Additionally, components and circuits can be single-ended or differential, and power supplies can be unipolar or bipolar.

An integrated circuit can implement some or all of the functionality of networking subsystem 1714. This integrated circuit can include hardware and/or software mechanisms that are used for transmitting wireless signals from electronic device 1700 and receiving signals at electronic device 1700 from other electronic devices. Aside from the mechanisms herein described, radios are generally known in the art and hence are not described in detail. In general, networking subsystem 1714 and/or the integrated circuit can include any number of radios. Note that the radios in multiple-radio embodiments function in a similar way to the described single-radio embodiments.

In some embodiments, networking subsystem 1714 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein includes receiving signals from other electronic devices and possibly performing one or more processing operations on the received signals).

In some embodiments, an output of a process for designing the integrated circuit, or a portion of the integrated circuit, which includes one or more of the circuits described herein can be a computer-readable medium such as, for example, a magnetic tape or an optical or magnetic disk. The computer-readable medium can be encoded with data structures or other information describing circuitry that can be physically instantiated as the integrated circuit or the portion of the integrated circuit. Although various formats can be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used a Wi-Fi communication protocol as an illustrative example, in other embodiments a wide variety of communication protocols and, more generally, wireless communication techniques can be used. Thus, the communication techniques can be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments can be performed in hardware, in software or both. For example, at least some of the operations in the communication techniques can be implemented using program instructions 1722, operating system 1724 (such as a driver for an interface circuit in networking subsystem 1714) or in firmware in an interface circuit networking subsystem 1714. Alternatively or additionally, at least some of the operations in the communication techniques can be implemented in a physical layer, such as hardware in an interface circuit or interface circuitry in networking subsystem 1714. In some embodiments, the communication techniques are implemented, at least in part, in a MAC layer and/or in a physical layer in an interface circuit in networking subsystem 1714.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

Moreover, while the preceding embodiments illustrated the use of wireless signals in one or more bands of frequencies, in other embodiments of the communication techniques electromagnetic signals in one or more different frequency bands are used. For example, these signals can be communicated in one or more bands of frequencies, including: a microwave frequency band, a radar frequency band, 900 MHZ, 2.4 GHz, 5 GHZ, 6 GHz, 60 GHz, and/or a band of frequencies used by a Citizens Broadband Radio Service or by LTE.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein can be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an antenna node configured to communicatively couple to an antenna; and
an interface circuit, communicatively coupled to the antenna node, configured to communicate with a second electronic device, wherein the interface circuit is configured to:
provide, addressed to at least the second electronic device, a request for an enhanced reduced neighbor report (RNR); and
receive the enhanced RNR, wherein the enhanced RNR comprises information specifying a non-collocated neighbor access-point identified by the second electronic device.

2. The electronic device of claim 1, wherein the enhanced RNR is compatible with an Institute of Electrical and Electronics Engineers (IEEE) 802.11bn standard.

3. The electronic device of claim 1, wherein the second electronic device comprises a second access point and the electronic device comprises a station or client that is associated with the second access point.

4. The electronic device of claim 1, wherein the enhanced RNR specifies a set of access points, the set of access points comprises the non-collocated neighbor access point, and the electronic device is configured to measure downlink receive signal strength indications (RSSIs) for one or more of the set of access points.

5. The electronic device of claim 4, wherein the electronic device is configured to select a third access point to associate with based at least in part on the enhanced RNR and the measured downlink RSSI for the third access point.

6. The electronic device of claim 5, wherein the electronic device is configured to measure the downlink RSSI during exchange of a request-to-send (RTS) frame and a clear-to-send (CTS) frame with the third access point.

7. The electronic device of claim 5, wherein the electronic device is configured to measure the downlink RSSI in less than 0.5 ms.

8. The electronic device of claim 5, wherein the electronic device is configured to measure the downlink RSSI using a physical preamble or an L-LTF field.

9. The electronic device of claim 1, wherein the request for the enhanced RNR is included in a probe request and the enhanced RNR is included in a probe response.

10. The electronic device of claim 9, wherein the request for the enhanced RNR is included in a request element in the probe request and the request element comprises ‘201.’

11. The electronic device of claim 10, wherein the probe request comprises an extended capabilities element and the extended capabilities element comprises bit 110 equal to ‘1.’

12. The electronic device of claim 10, wherein the probe request comprises a selective service set (SSID) list or a short SSID list to request information about one or more SSIDs associated with one or more corresponding access points.

13. The electronic device of claim 9, wherein the probe request comprises a time duration of the enhanced RNR.

14. The electronic device of claim 1, wherein the information is based at least in part on a type of the non-collocated neighbor access-point.

15. The electronic device of claim 14, wherein the type comprises which Institute of Electrical and Electronics Engineers (IEEE) 802.11 standard(s) the non-collocated neighbor access-point is compatible.

16. The electronic device of claim 1, wherein the enhanced RNR comprises a target beacon transmission time (TBTT) information field type equal to ‘2.’

17. The electronic device of claim 1, wherein the enhanced RNR comprises one or more of: neighbor access-point dynamic attributes; multi-link device (MLD) parameters; or multi-link mobility domain (MLMD) parameters.

18. The electronic device of claim 1, wherein the enhanced RNR comprises one or more of: a physical layer version, physical layer capabilities, security support, or basic service set (BSS) load.

19. A method for requesting an enhanced reduced neighbor report (RNR), comprising:
by an electronic device:
providing, addressed to at least a second electronic device, a request for an enhanced RNR; and
receiving the enhanced RNR, wherein the enhanced RNR comprises information specifying a non-collocated neighbor access-point identified by the second electronic device.

20. A second electronic device, comprising:
an antenna node configured to communicatively couple to an antenna; and
an interface circuit, communicatively coupled to the antenna node, configured to communicate with an electronic device, wherein the interface circuit is configured to:
receive, associated with the electronic device, a request for an enhanced reduced neighbor report (RNR); and
provide, addressed to the electronic device, the enhanced RNR, wherein the enhanced RNR comprises information specifying a non-collocated neighbor access-point of the second electronic device.
